(19) United States
(12) Patent Application Publication
(10) Pub. No.: US 2008/0267522 A1
(43) Pub. Date: Oct. 30, 2008

(54) IMAGE PROCESSOR, IMAGE PROCESSING METHOD AND COMPUTER READABLE MEDIUM FOR IMAGE PROCESSING PROGRAM

(75) Inventor: Masanobu KOBAYASHI, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/108,584

(22) Filed: Apr. 24, 2008

(30) Foreign Application Priority Data
Apr. 27, 2007 (JP) 2007-118881

(51) Int. Cl. G06K 9/36; G06K 9/40

(52) U.S. Cl. 382/254; 382/284

(57) ABSTRACT

An image processor is an image processor generating a composed image by composing together two or more images, and includes: image data acquisition unit that acquires image data groups as a result of image capturing of an image-capturing target with varying amounts of exposure; and image data composite unit that composes, out of the image data groups acquired by the image data acquisition unit, any of the image data groups corresponding to at least a partial range of the composed image, and generating image data of another piece of composed image.

### BACKGROUND

1. Technical Field

The present invention relates to an image processor, an image processing method, and a computer-readable recording medium recorded with an image processing program, and relates to an image processor, an image processing method, and a computer-readable recording medium recorded with an image processing program that are suitable for capturing, as a piece of image, an image of a range including a plurality of areas whose appropriate exposure times vary.

2. Related Art

The exposure time for image capturing is an important factor for determining the quality of the resulting captured image. When image capturing is performed with any inappropriately-set exposure time, there may be a case of not being able to determine what the image-capturing target is because it is blocked up and looks black on the resulting image irrespective of the fact that it can be visually available for human eyes. Contrarily, any reflected light will be imaged white on the resulting image, thereby causing so-called white-out conditions. Also in such a case, the image-capturing target may not be determined.

As a previous technology for solving such problems, there is Patent Document 1 in which any images showing the appropriate brightness are cut out for composite from a plurality of images varying in amount of exposure, and a single piece of image is configured. With the invention of Patent Document 1, however, because the composing images are varying in luminance level, an image called false contour problematically appears at the composite boundary in the image as a result of the image composite.

FIGS. 11A to 11E are each a diagram for illustrating the occurrence of false contour. FIGS. 11A, 11B, and 11C are each a graph showing the output characteristics of a CCD camera 101, in which the vertical axis indicates luminance signal levels of images varying in exposure time and the lateral axis indicates amounts of incident light. In the FIGS. 11A to 11E examples, the exposure time of FIG. 11B is the standard exposure time, and FIG. 11A shows the characteristics with the exposure time shorter than that of FIG. 11B, and FIG. 11C shows the characteristics with the exposure time longer than that of FIG. 11B.

FIGS. 11D and 11E show the exposure characteristics when three images whose exposure characteristics are shown in FIGS. 11A, 11B, and 11C are selectively composed together. Generally, as described in JP-A-63-306777, after the luminance levels of FIGS. 11A, 11B, and 11C are respectively adjusted, as shown in FIG. 11D, the amounts of incident lights are each used as a basis for image composite. In the FIG. 11D example, the exposure characteristics of FIG. 11A are selected in the area of A in the drawing. Further, the exposure characteristics of FIG. 11B are selected in the area of B in the drawing, and the exposure characteristics of FIG. 11C are selected in the area of C in the drawing.

Note here that FIG. 11B shows the example when the image composite is ideally completed, and at both boundaries I and II in the areas A, B, and C, the luminance level shows the linearity with respect to the amount of incident light. However, when an output deviation of +10% is observed due to any noise occurred to the data with the exposure characteristics of FIG. 11B, for example, as shown in FIG. 11E (the drawing shows the example of +10%), the linearity is lost from the luminance level with respect to the amount of incident light, and thus the boundaries I and II are observed with discontinuous points. At any portion of the image where the discontinuity of luminance signals reaches the level visually available for human eyes, the false contour is observed.

For the purpose of eliminating such false contour from any composed images, various many technologies have been proposed. Such technologies include JP-A-7-131718 and JP-A-2000-78594. In JP-A-7-131718, prior to composing a plurality of images varying in amount of exposure, in the images, the luminance level is adjusted to be the same for the images of appropriate brightness (images with no block-up), thereby adjusting the luminance level to be the same for a plurality of images.

Moreover, in the invention of JP-A-2000-78594, the circuit for use with image composite is reduced in size by performing luminance synthesis for a plurality of images before color separation.

In both JP-A-7-131718 and JP-A-2000-78594, however, cut-out images are composed together. Therefore, when composing images have each different luminance signal level noise, the luminance level will lose the linearity with respect to the amount of incident light, thereby possibly causing false contour.

Moreover, in both JP-A-7-131718 and JP-A-2000-78594, the image composite is performed after a plurality of composing image data are adjusted in luminance level, and it thus cannot prevent occurrence of false contour depending on the adjustment state of the luminance level.

### SUMMARY

An object of the invention is to provide an image processor, an image processing method, and a computer-readable recording medium recorded with an image processing program, which all can prevent more perfectly any possible occurrence of false contour.

An image processor of the invention is an image processor generating a composed image by composing together two or more images, including: image data acquisition unit that acquires image data groups as a result of image capturing of an image-capturing target with varying amounts of exposure; and image data composite unit that composes, out of the image data groups acquired by the image data acquisition unit, any of the image data groups corresponding to at least a partial range of the composed image, and generating image data of another piece of composed image.

With such an invention, a composed image can be generated by composing together image data of the same range in images captured with varying amounts of exposure. In this manner, no boundary is observed between the images varying in amount of exposure, thereby being able to provide an image processor that can prevent more perfectly any possible occurrence of false contour.

The image processor of the invention is also further including: normalization unit that normalizes, within a predetermined value range, the image data included in the image data groups, and the image data composite unit composes together the image data included in the image data groups through the normalization by the normalization unit.

With such an invention, image data can be composed after normalization thereof so that any influence of values of the image data over the resulting composed image can be made uniform.

The image processor of the invention is also characterized in that the image data acquisition unit acquires, as the image data, data provided by image capturing unit including a photoelectric conversion element after conversion into an electric signal, and characteristics adjustment unit is further provided for adjusting the composed image data generated by the image composite unit based on characteristics of the image capturing unit.

With such an invention, with respect to the amount of exposure, the linearity of the values of the image data can be retained due to the characteristics or others of a sensor cell array using a CCD or others so that the resulting composed image can be high in image quality.

The image processor of the invention is also further including: image data divide unit that divides at least a part of the image data included in the image data groups acquired by the image data acquisition unit; and image data recomposite unit that recomposes divide pieces of the image data divide by the image data divide unit. The image data composite unit composes a part of the divide pieces of the image data divide by the image data divide unit, and the image data recomposite unit recomposes a part of the image data as a result of the image composite by the image data composite unit and any of the remaining image data not yet composed.

With such an invention, only a part of a piece of image can be a composed image. Accordingly, with the composed image only of any needed portion of the image, the process of image composite can be executed with efficiency while keeping the image quality.

An image processing method of the invention is an image processing method generating a composed image by composing two or more images, including: an image data acquisition step of acquiring image data groups as a result of image capturing of an image-capturing target with varying amounts of exposure; and an image data composite step of composing, out of the image data groups acquired in the image data acquisition step, any of the image data groups corresponding to at least a part of the composed image, and generating image data of another piece of composed image.

With such an invention, a composed image can be generated by composing together image data of the same range in images captured with varying amounts of exposure. In this manner, no boundary is observed between the cut-out images varying in amount of exposure, thereby being able to provide an image processing method that can prevent more perfectly any possible occurrence of false contour.

A computer-readable recording medium recorded with an image processing program of the invention is a computer-readable recording medium recorded with an image processing program for generating a composed image by composing two or more images, the program making a computer execute: an image data acquisition function of acquiring image data groups as a result of image capturing of an image-capturing target with varying amounts of exposure; and an image data composite function of composing, out of the image data groups acquired by the image data acquisition function, any of the image data groups corresponding to at least a partial range of the composed image, and generating image data of another piece of composed image.

With such an invention, a composed image can be generated by composing together image data of the same range in images captured with varying amounts of exposure. In this manner, no boundary is observed between the cut-out images varying in amount of exposure, thereby being able to provide a computer-readable recording medium recorded with an image processing program that can prevent more perfectly any possible occurrence of false contour.

### BRIEF DESCRIPTION OF THE DRAWINGS

FIG. 1 is a diagram for illustrating the configuration of an image processor of a first embodiment of the invention.

FIG. 2 is a diagram showing a sensor cell array including a CCD for mounting on a CCD camera of FIG. 1.

FIGS. 3A, 3B, and 3C are each a diagram for illustrating the normalization of image data, and showing the state in which luminance signal levels corresponding to a range of every amount of incident light are assigned to the luminance signal levels of 0 to 256.

FIGS. 4A, 4B, and 4C are each a diagram for illustrating the normalization of image data, and showing the state in which other image data is normalized in accordance with the longest exposure time.

FIG. 5 is a diagram showing the luminance signal levels as a result of composite of the luminance signal levels of image data A, B, and C.

FIGS. 6A and 6B are each a diagram for illustrating the adjustment of the luminance signal level to be performed by a gradation adjustment unit of FIG. 1.

FIG. 7 is a diagram showing the output characteristics that are linearized in the first embodiment of the invention.

FIG. 8 is a flowchart for illustrating a computer program to be run by the image processor of the first embodiment of the invention.

FIG. 9 is a diagram for illustrating the concept of a second embodiment of the invention.

FIG. 10 is a diagram for illustrating the configuration of an image processor of the second embodiment of the invention.

FIGS. 11A to 11E are each a diagram for illustrating the occurrence of general false contour.

### DESCRIPTION OF EXEMPLARY EMBODIMENTS

In the below, first and second embodiments of the invention are described by referring to the accompanying drawings.

### First Embodiment

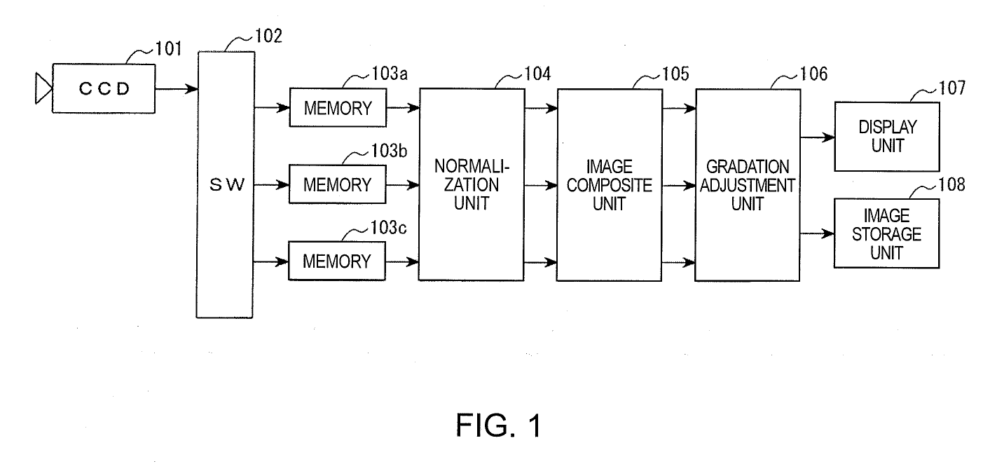

FIG. 1 is a diagram for illustrating the configuration of an image processor of a first embodiment of the invention. The image processor of the drawing is configured to include a CCD camera 101, a switch (SW) 102 for allocating data (image data) captured by the CCD camera 101 to a plurality of memories 103a, 103b, and 103c, a normalization unit 104 for normalizing the image data stored after being allocated to the memories 103a to 103c, an image composite unit 105 for composing together the normalized image data, a gradation adjustment unit 106 for adjusting the luminance level of the composed image data, and a display unit 107 such as display screen for display of the image data after adjustment or an image storage unit 108 for storage thereof.

Such an image processor is an image processor that generates a composed image by composing two or more images, and image data A, B, and C are image data derived by capturing a single piece of image-capturing target with varying amounts of exposure. Note that, in the first embodiment, the image data A, B, and C are collectively referred also to as an image data group.

Note that, in the first embodiment, presumably, the image data A, B, and C with varying amounts of exposure are generated by changing the exposure time. The exposure time T1 of the image data A, the exposure time T2 of the image data B, and the exposure time T3 of the image data C have the relationship of

T1<T2<T3, and

presumably, T1:T2:T3=2:3:6

The CCD camera 101 generates the image data A, B, and C by image capturing of a single piece of image-capturing target with varying amounts of exposure. The CCD camera 101 is an image capturing unit including a photoelectric conversion element (CCD) that converts any receiving analog signal into an electric signal before output.

Moreover, in the first embodiment, the luminance signal level to be output by the CCD camera 101 is referred to as pixel value, data of correlation between the pixel value and coordinates of a pixel in an image having the pixel value is referred to as image data. That is, the image data is data defined by the coordinates of a pixel and the luminance signal level.

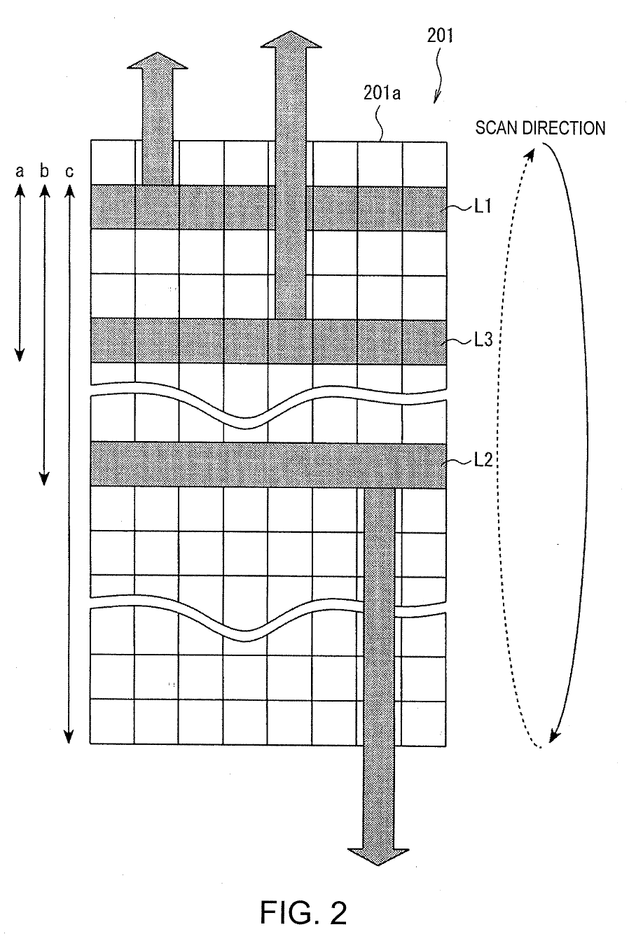

Herein, by referring to FIG. 2, described is the configuration of the CCD camera 101 performing image capturing of a single piece of image-capturing target with varying exposure times.

FIG. 2 is a diagram showing a sensor cell array 201 including a CCD 201a to be mounted on the CCD camera 101. In the sensor cell array 201, the exposure area is provided with three reading lines L1, L2, and L3 for reading of electric charge accumulated in the CCD 201a. The CCD 201a is subjected to scanning repeatedly in the scan direction shown in the drawing so that the accumulated electric charge is read out.

The reading line L1 is a reading line for reading and resetting the electric charge accumulated in the largest number of CCDs. Reading with resetting is also referred to as destructive reading. The data of the electric charge read by the reading line L1 is directed into an A/D conversion unit via an AFE (Analog Front End) that is not shown, and the result is digital data (image data). The image data based on the data of the electric charge read by the reading line L1 is the image data C whose exposure time is the longest in the first embodiment.

The image data read by the reading line L2 is the image data B of the standard exposure time in the first embodiment. The reading line L3 is a reading line for reading out the electric charge accumulated in the least number of CCDs. The image data read by the reading line L3 is the image data A whose exposure time is the shortest in the first embodiment. Reading by the reading lines L2 and L3 is both non-destructive reading with no resetting.

During one period of exposure, the reading and resetting of the electric charge by the reading line L1 is performed separately from the non-destructive reading by the reading lines L2 and L3.

Such control over the reading timing is implemented by an electronic shutter function. Note that, in the first embodiment, such a configuration is surely not the only option, and the amount of exposure may be changed through control over the aperture of the CCD camera 101.

The memory 103a is a memory of similar configuration, and receives and captures the image data coming from the CCD 101 via the switch 102. The memory 103a accumulates therein the image data A, the memory 103b accumulates therein the image data B, and the memory 103c accumulates therein the image data C.

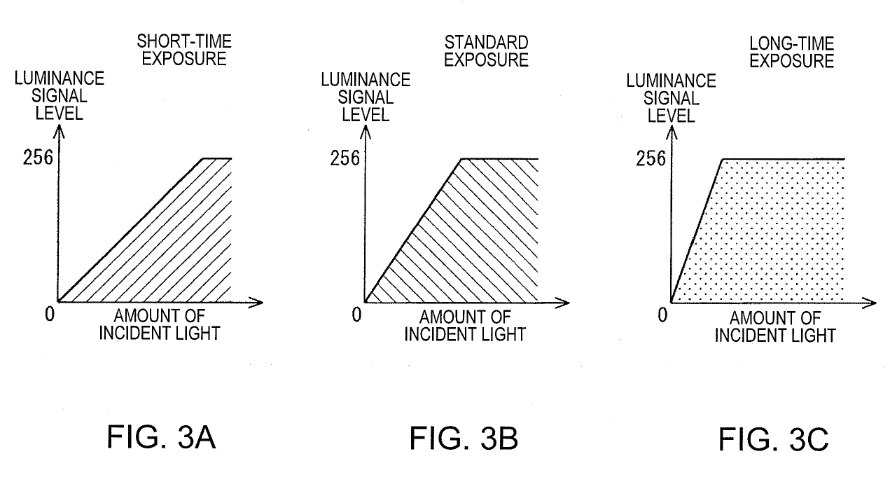

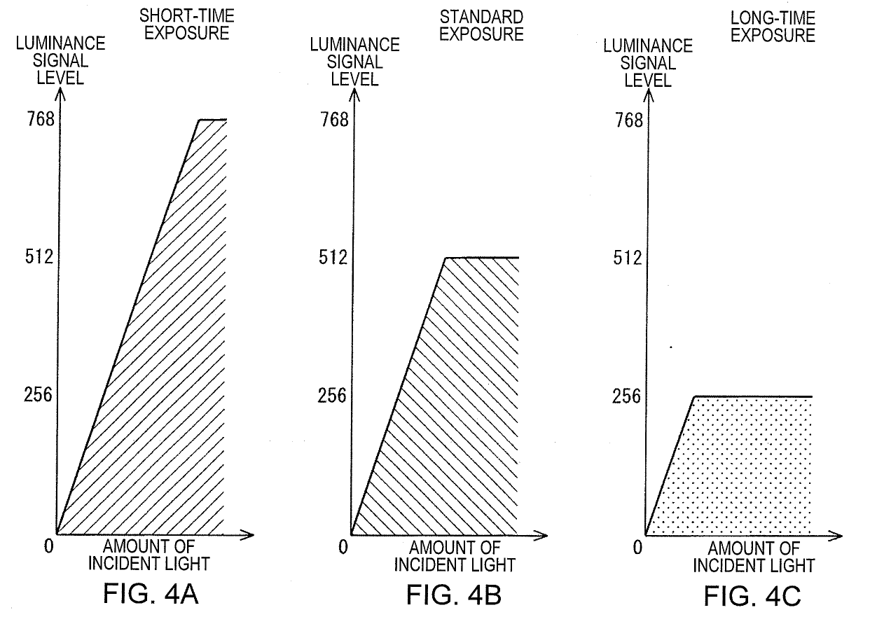

The image data accumulated in the respective memories 103a, 103b, and 103c are normalized in the normalization unit 104. FIGS. 3A, 3B, 3C, 4A, 4B, and 4C are each a diagram for illustrating the normalization of the image data.

FIGS. 3A, 3B, and 3C each show the state in which, for the image data A, B, and C, the luminance signal levels corresponding to the range of every amount of incident light are assigned to the levels of 0 to 256 (luminance signal levels). FIGS. 4A, 4B, 4C each show the state in which the image data A and the image data B are normalized in accordance with the exposure time T3 of the image data C, which is the longest exposure time.

Assuming here is that the luminance signal levels of the normalized image data A are A_NTc(x, y, R), B_NTc(x, y, R), and C_NTc(x, y, R), and the image data A, B, and C before the normalization are respectively A_Ta(x, y, R), B_Tb(x, y, R), and C_Tc(x, y, R). A_NTc(x, y, R), B_NTc(x, y, R), C_NTc(x, y, R), A_Ta(x, y, R), B_Tb(x, y, R), and C_Tc(x, y, R) all indicate the image data of R from those of R, G, and B. Herein, the variables x and y each indicate the coordinates of a pixel with the luminance signal level thereof. A_NTc(x, y, R), B_NTc(x, y, R), C_NTc(x, y, R), A_Ta(x, y, R), B_Tb(x, y, R), and C_Tc(x, y, R) have the relationship expressed as below.

A_{—}NTc(x,y,R)=A_{—}Ta(x,y,R)·(Tc/Ta)

B_{—}NTc(x,y,R)=B_{—}Tb(x,y,R)·(Tc/Tb)

C_{—}NTc(x,y,R)=C_{—}Tc(x,y,R)

These expressions are established similarly to the images of G and B.

The image composite unit 105 composes together the image data A, B, and C normalized in the normalization unit 104. Among the image data A, B, and C as a result of image capturing of a single piece of image-capturing target with varying amounts of exposure, the image composite is performed by composing together the image data A corresponding to at least a partial range of the image A, and in the image B, the image data B corresponding to a range of the range, and in the image C, the image data C corresponding to a range of the range.

Note that, in the first embodiment, the image data A is the one for generating the entire area (all areas) of the image A. The image data B and the image data C are also each image data corresponding to the entire area of the image A.

That is, in the first embodiment, the normalized image data A, B, and C are composed together by addition of the luminance signal levels with the same coordinates in the images. Note that, in the first embodiment, such a configuration is surely not the only option, and the image data may be assigned weights for addition. Alternatively, any other computation but not the addition may be applied for image composite.

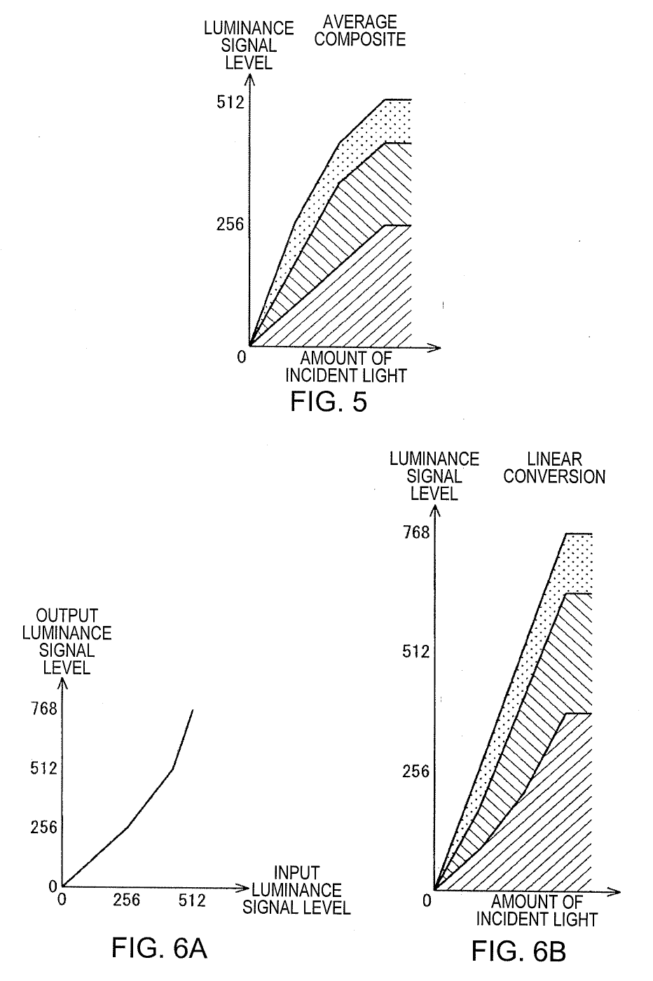

The gradation adjustment unit 106 adjusts the luminance signal levels as a result of image composite in consideration of the characteristics of the CCD camera 101. That is, the image data A, B, and C as a result of image composite by the image composite unit 105 do not show the linearity of the luminance signal levels with respect to the amount of incident light. FIG. 5 is a diagram showing the luminance signal level as a result of composite of the luminance signal levels of the image data A, B, and C. This composite is performed by adding the luminance signal levels of R of the image data A, B, and C for averaging (multiplication of ⅓).

FIGS. 6A and 6B are each a diagram for illustrating the adjustment of the luminance signal levels to be performed by the gradation adjustment unit 106. The gradation adjustment unit 106 adjusts the output characteristics of the luminance signal levels of FIG. 5 by referring to an LUT (Look-Up Table) of FIG. 6A. In the LUT in the drawing, the lateral axis indicates the luminance signal level values to be input to the gradation adjustment unit 106, and the vertical axis indicates the luminance signal level values to be output from the gradation adjustment unit 106.

Such a LUT is for performing the adjustment in such a manner as to output the incident luminance signal level, the higher the level the larger the value. The LUT can adjust any tendency of the luminance signal level values coming from the CCD camera 101 getting smaller as the amount of incident light is increased.

FIG. 6B shows the luminance signal levels of FIG. 5 adjusted by referring to the LUT of FIG. 6A. As shown in the drawing, the luminance signal levels after adjustment show the preferable linearity with respect to the amount of incident light. Such a process is also referred to as linearization in the first embodiment.

In the configuration described as such, the CCD camera functions as image data acquisition unit. The CCD camera has been acquired, as image data, data provided by the sensor cell array 201 including the CCD 201a after conversion into an electric signal, and the CCD 201a functions as a photoelectric conversion element, and the sensor cell array 201 functions as image capturing unit. Moreover, the normalization unit 104 functions as normalization unit, the image composite unit 105 functions as image composite unit, and the gradation adjustment unit 106 functions as characteristics adjustment unit.

In the first embodiment, the luminance signal levels are composed together at the level of every incident light so that there is no possibility of causing discontinuity to the luminance signal level at the boundaries of the amounts of incident light.

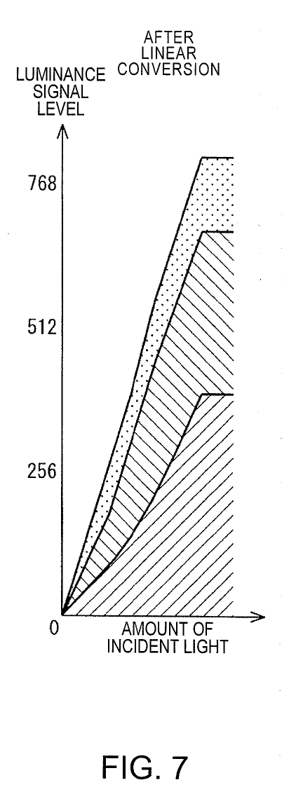

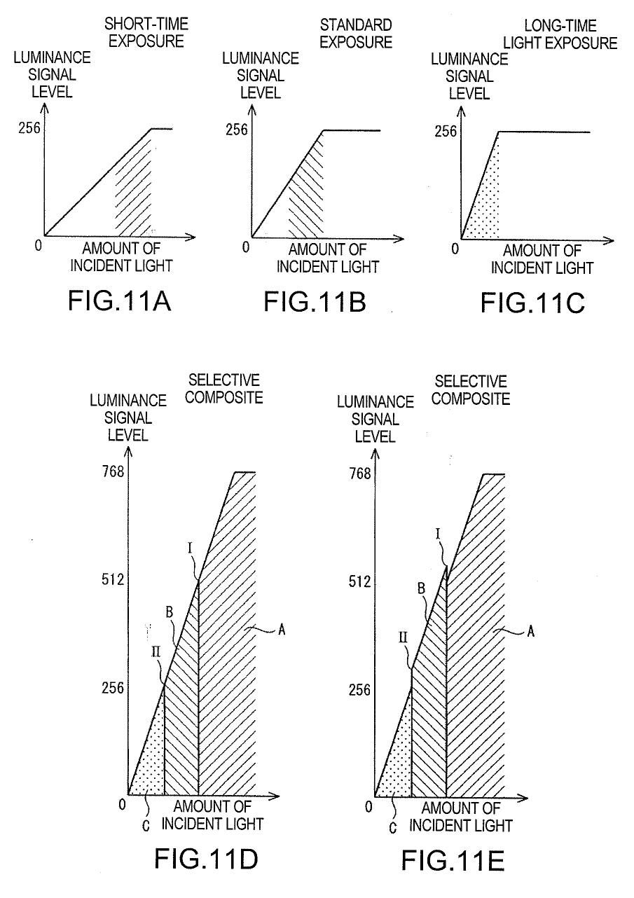

Moreover, when the luminance signal levels as a result of composite of FIG. 5 show a deviation of 10%, the linearization leads to the output characteristics of FIG. 7. Although the output characteristics of FIG. 7 are with some degree of discontinuity, they are sufficiently low in level compared with the discontinuity of FIG. 11E.

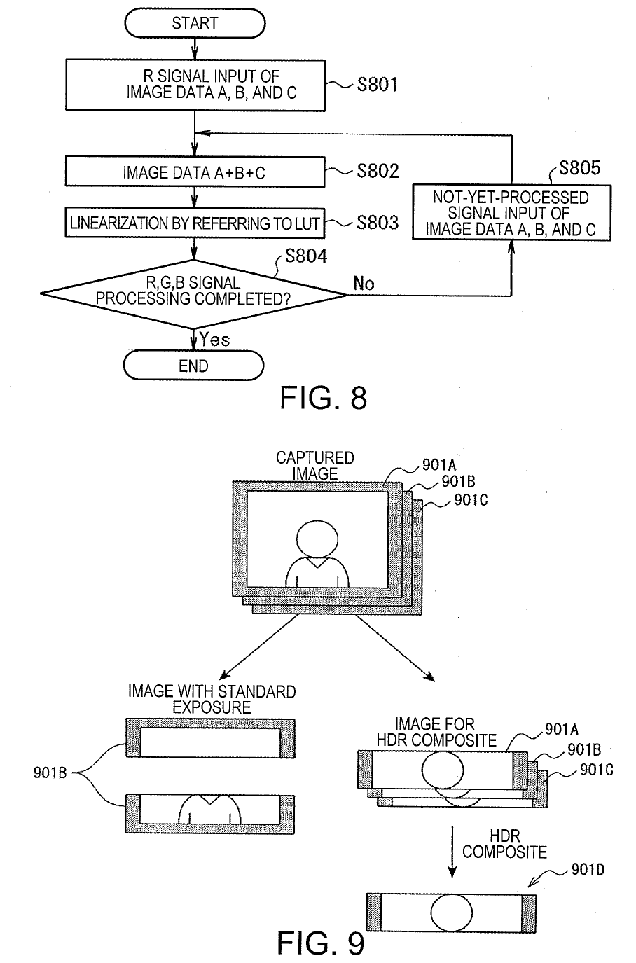

FIG. 8 is a flowchart for illustrating an image processing method and a computer program to be executed in the image processor of the first embodiment described above. This flowchart is executed by the normalization unit 104, the image composite unit 105, and the gradation adjustment unit 106.

In the first embodiment, first of all, the normalization unit 104 receives R signals of the image data A, B, and C from the memory 103a (S801). Then, each of the input image data is normalized. The image composite unit 105 composes together the normalized image data A, B, and C (S803), and the gradation adjustment unit 106 performs linearization by referring to the LUT of FIG. 6A.

In the normalization unit 104, a control unit that is not shown determines whether such image processing is through for all of R, G, and B (S805), and when the processing is not yet through (S805: No), the image processing is repeated with input of any not-yet-processed signals of the image data A, B, and C. When all of R, G, and B are through with the image processing (S805: Yes), the flowchart of the drawing is ended.

In the first embodiment described as such, because no boundary is observed between images of different amount of exposure, any possible occurrence of false contour can be prevented more perfectly. Moreover, because the image data is normalized prior to image composite, any possible influence of the values of the image data A, B, and C over the resulting composed image can be made uniform.

Moreover, it is generally known that the sensor cell array 201 shows the change of its output characteristics depending on the amount of exposure. In the first embodiment, the image data after image composite is linearized, and thus the influence of any change observed in the output characteristics over the image data can be reduced so that the resulting composed image can be high in image quality.

Note that the image processing method of the first embodiment described as such can be applied also at places of printing data of images after taking it into keeping for a while, i.e., places of offering so-called print service.

Moreover, in the first embodiment described above, the image data A, B, and C acquired by the CCD camera 101 are entirely used for generating the composed image data. The first embodiment is surely not restrictive to such a configuration, and alternatively, at least a part of image data of the acquired image data may be composed together.

### Second Embodiment

Described next is a second embodiment of the invention. In an image processor of the second embodiment, unlike the first embodiment in which the image data A, B, and C are entirely used for image composite, the image data A, B, and C are partially composed, and using the image data as a result of exposure of the remaining parts with the standard exposure time, a piece of image is generated.

FIG. 9 is a diagram for illustrating the concept of the second embodiment. In the shown example, a piece of composed image 901D is generated by partially (HDR (High Dynamic Range) composing image) subjecting, to HDR composite, a captured image 901A generated by the image data A, a captured image 901B generated by the image data B, and a captured image 901C generated by the image data C. Moreover, a composed image is generated by using the captured image 901B as a result of image capturing of the portion not including the HDR composing images of the captured image 901 A, B, and C with the standard exposure time.

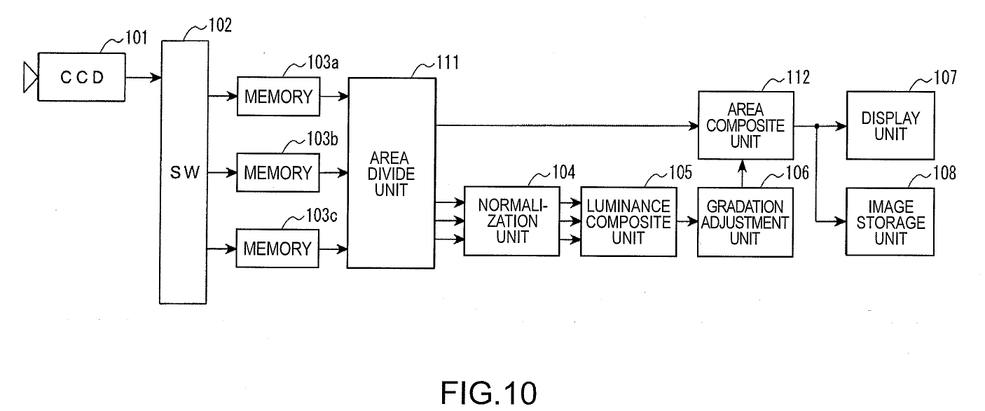

FIG. 10 is a diagram for illustrating the configuration of the image processor of the second embodiment. In the shown configuration, any component similar to that of FIG. 1 is provided with the same reference numeral, and is not described twice.

The image processor of the second embodiment is configured to include an area divide unit 111 that divides the image data A, B, and C acquired by the CCD camera 101 and accumulated in the memories 103a, 103b, and 103c, and an area composite unit 112 that composes again the divide pieces of the image data.

The image composite unit 105 is so configured as to compose the HDR composing images being parts of the divide pieces of the image data A, B, and C, and the area composite unit 112 is so configured as to compose parts of the image data A, B, and C being the results of composite by the image composite unit 105, and any of the image data A, B, and C that are not yet composed.

The area divide unit 111 divides the image data A, B, and Con the basis of an area of a captured image. This dividing is so performed as to separate between any area of a standard image where white-out conditions and blocked-up pixels are observed, i.e., any area of an image showing a large change of amount of incident light, and any area of an image showing a relatively small change of amount of incident light.

The image data of any area showing a large change of amount of incident light is normalized, composed, and linearized by the normalization unit 104, the image composite unit 105, and the gradation adjustment unit 106, and the result is then directed into the area composite unit 112. On the other hand, the image data of any area of an image showing a small change of amount of light captured with the standard exposure time is directed into the area composite unit 112 as it is.

The area composite unit 112 composes together the image data as a result of composite with the image data of an image captured with the standard exposure time. This composite is not for adding together the luminance signal levels unlike the luminance composite unit. That is, the coordinates of a partial area of the composed image are correlated with the luminance signal level as a result of synthesis, and the coordinates of the remaining area are correlated with the luminance signal level with the standard exposure time. With such composite, the resulting composed image is partially an HDR composed image, and the remaining part is an image captured with the standard exposure time.

In the second embodiment described above, only a part of a piece of image can be a composed image. Therefore, with the composed image only of any needed part (e.g., portion of human face) of the image, the process of composite can be performed with efficiency while keeping the image quality.

The entire disclosure of Japan Patent Application No. 2007-118881 filed on Apr. 27, 2007 is expressly incorporated by reference herein.

What is claimed is:

1. An image processor generating a composed image by composing together two or more images, comprising:
image data acquisition unit that acquires image data groups as a result of image capturing of an image-capturing target with varying amounts of exposure; and
image data composite unit that composes, out of the image data groups acquired by the image data acquisition unit, any of the image data groups corresponding to at least a partial range of the composed image, and generating image data of another piece of composed image.

2. The image processor according to claim 1, further comprising:
normalization unit that normalizes, within a predetermined value range, the image data included in the image data groups, wherein
the image data composite unit composes together the image data included in the image data groups through the normalization by the normalization unit.

3. The image processor according to claim 1,
wherein the image data acquisition unit acquires, as the image data, data provided by image capturing unit including a photoelectric conversion element after conversion into an electric signal, and
characteristics adjustment unit is further provided for adjusting the composed image data generated by the image composite unit based on characteristics of the image capturing unit.

4. The image processor according to claim 1, further comprising:
image data divide unit that divides at least a part of the image data included in the image data groups acquired by the image data acquisition unit; and
image data recomposite unit that recomposes divide pieces of the image data divide by the image data divide unit, wherein
the image data composite unit composes a part of the divide pieces of the image data divide by the image data divide unit, and the image data recomposite unit recomposes a part of the image data as a result of the image composite by the image data composite unit and any of the remaining image data not yet composed.

5. An image processing method for generating a composed image by composing two or more images, comprising:
an image data acquisition step of acquiring image data groups as a result of image capturing of an image-capturing target with varying amounts of exposure; and
an image data composite step of composing, out of the image data groups acquired in the image data acquisition step, any of the image data groups corresponding to at least a partial range of the composed image, and generating image data of another piece of composed image.

6. A computer-readable recording medium recorded with an image processing program for generating a composed image by composing two or more images, the program making a computer execute:
an image data acquisition function of acquiring image data groups as a result of image capturing of an image-capturing target with varying amounts of exposure; and
an image data composite function of composing, out of the image data groups acquired by the image data acquisition function, any of the image data groups corresponding to at least a partial range of the composed image, and generating image data of another piece of composed image.
